(19) United States
(12) Patent Application Publication
(10) Pub. No.: US 2015/0081263 A1
(43) Pub. Date: Mar. 19, 2015

(54) PRODUCTION SIMULATION APPARATUS AND PRODUCTION SIMULATION METHOD

(71) Applicant: HITACHI, LTD., Tokyo (JP)

(72) Inventors: Satoshi Nagahara, Tokyo (JP); Hisaya Ishibashi, Tokyo (JP)

(73) Assignee: Hitachi, Ltd., Tokyo (JP)

(21) Appl. No.: 14/395,565

(22) PCT Filed: Apr. 15, 2013
(86) PCT No.: PCT/JP2013/061143

§ 371 Date: Oct. 20, 2014

(30) Foreign Application Priority Data
Apr. 20, 2012 (JP) 2012-096183

(51) Int. Cl. G06F 17/50

(52) U.S. Cl. CPC G06F 17/5009
USPC 703/7

(57) ABSTRACT

According to the present invention, an accurate simulation result is obtained and computation time is shortened, by parallel computation of a production simulation executed by a plurality of processors. A target product line is divided into a plurality of blocks, and event groups which can be computed in parallel while acquiring accurate simulation results are formed based on the order of execution dates and times of the events in the divided block. First, a step effect relationship which shows whether or not an event computation process in a certain step affects an event computation process in another step is acquired, based on a production line configuration such as a step order and resource sharing relationship between the steps. Next, the production line is divided into a plurality of blocks which do not affect each other by putting the steps that affect one another into a block. In a case where the earliest execution date and time of an event in a certain block is later than the earliest execution date and time of an event in another block which the certain block affects, an event group which can be computed in parallel is formed by determining that the event with the earliest execution date and time of the certain block is an event which can be computed in parallel. Lastly, the formed event group is allocated to a plurality of processors so as to be computed in parallel, and thus, computation time is shortened.

### 1. TECHNICAL FIELD

The present invention relates to a production simulation technology of predicting flow of a production line.

### 2. BACKGROUND ART

A production simulation for predicting flow of a production line is effective, for realizing highly efficient production planning or production line design. A representative method of the production simulation is an event-driven simulation. In this method, movement of a component between production steps or completion of an operation in the production step is defined as an event, and occurrence of chain events is modeled so that an event in which “a component A is moved to a step 1” is completed and then an event in which “the operation of the component A in the step 1 is completed” occurs, for example. Future flow is predicted by simulating completion and occurrence of events on a computer. Herein, each event includes the execution date and time of the event, and in this method, time is virtually spent sequentially executing a computation process of an event with the earliest execution date and time, among a list of a plurality of events (event list). Other events in the event list are in a process standby state until the computation process of the event with the earliest execution date and time is completed. Accordingly, in this method, it is necessary to process the events in the event list one by one in sequence, and the computation takes a long time in the case of a large-scale target production line.

As a method of solving the problems described above, there is a method of shortening the computation time by performing parallel computation of the plurality of events with a plurality of processors. PTL 1, for example, discloses a method of forming an event group by combining the event with the earliest execution date and time from the event list and events with execution date and time in a set period from the earliest execution date and time, and allocating the computation process of the event group to the plurality of processors.

### CITATION LIST

### Patent Literature

PTL 1: JP-A-6-325121

### SUMMARY OF INVENTION

### Technical Problem

In the parallel computation method disclosed in PTL 1, the events with the event execution date and time in a set period are determined to be computable in parallel. However, in the case of the long set period, the events which are not to be computed in parallel may be computed in parallel, and accurate simulation results may not be obtained. For example, it is assumed that an event A and an event B are in the event list and execution date and time of both of them are in the set period. Herein, when the execution date and time of the event C which occurs due to the computation process of the event A is set between the event A and the event B, the process results of the events B and C may be different depending on whether the events A and B are computed or not. On the other hand, in the case of the short set period, the possibility of inaccurate simulation results is low, but the number of events which can be computed in parallel is small due to the small number of events in the set period, and the plurality of processors cannot be efficiently operated, and accordingly a computation time shortening effect is decreased. Objects of the invention are to perform an accurate simulation and to shorten the computation time.

### Solution to Problem

In order to solve the problems, according to an aspect of the invention, there is provided a production simulation apparatus which predicts flow of a production line, the apparatus including: an input unit which receives the input of introduction plan information for specifying date and time to introduce a component to the production line, step information for specifying content of each step of the production line, and step route information for specifying the order of the steps, which are the input information items of the simulation; a storage unit which stores the information input by the input unit; and a control unit which executes a process of dividing the step of the production line into a plurality of blocks so that event computation process results do not mutually affect the blocks, by using the step information and the step route information, a process of forming an event group which can be computed in parallel from the order of execution date and time of the event in each formed block based on the introduction plan information, a process of allocating the event group to a plurality of processors, and a computation process of the event allocated to each processor.

### Advantageous Effects of Invention

According to the invention, a user of the apparatus can execute an accurate production simulation in a short time.

### BRIEF DESCRIPTION OF DRAWINGS

FIG. 1 is a functional block diagram of a production simulation apparatus.

FIG. 2 is a schematic view showing an example of a production line.

FIG. 3 is a schematic view of an introduction plan information table.

FIG. 4 is a schematic view of a step route information table.

FIG. 5 is a schematic view of a step information table.

FIG. 6 is a schematic view of a resource information table.

FIG. 7 is a schematic view of a step effect relationship information table.

FIG. 8 is a schematic view of a block precedence relationship information table.

FIG. 9 is a schematic view of an event list information table.

FIG. 10 is a schematic view of a block date and time information table.

FIG. 11 is a schematic view of a simulation result information table.

FIG. 12 is a schematic view of a computer.

FIG. 13 is a flowchart showing a production simulation process.

FIG. 14 is a flowchart showing a step division process.

FIG. 15 is a flowchart showing a step effect relationship acquisition process 1.

FIG. 16 is a flowchart showing a step effect relationship acquisition process 2.

FIG. 17 is a flowchart showing a step effect relationship acquisition process 3.

FIG. 18 is a flowchart showing a block creation process.

FIG. 19 is a flowchart showing a parallel-computable event extraction process.

FIG. 20 is a flowchart showing the parallel-computable event extraction process.

FIG. 21 is a flowchart showing an event parallel computation process.

FIG. 22 is a schematic view showing a step division process and a parallel-computable event extraction process.

FIG. 23 is a schematic view showing an example of an output screen.

FIG. 24 is a schematic view showing an example of an output screen.

### DESCRIPTION OF EMBODIMENTS

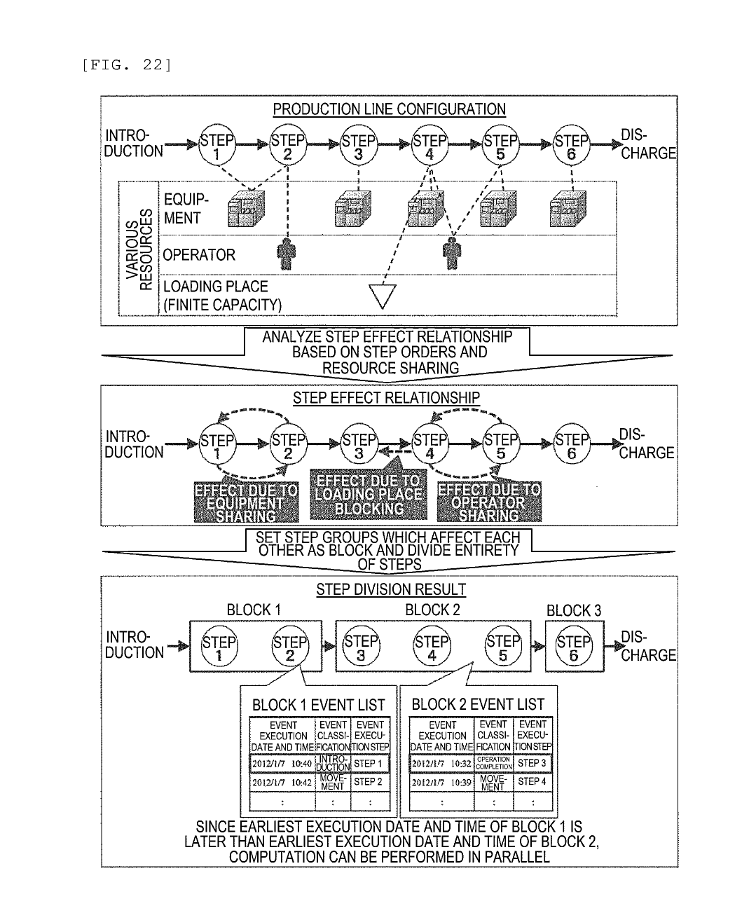

In the invention, a target production line is divided into a plurality of blocks, and event groups which can be computed in parallel while acquiring accurate simulation results are formed based on the order of execution dates and times of the events in the divided block. FIG. 22 shows a schematic view of the invention. In the invention, a step effect relationship (middle part of FIG. 22) which shows whether or not an event computation process in a certain step affects an event computation process in another step is acquired, based on information of production line configurations (such as the flow of steps or a utilization resource in each step) as shown in an upper part of FIG. 22. For example, in FIG. 22, step 1 and step 2 affect each other regarding order in which to share equipment. In addition, since a step 4 uses a component loading place with finite capacity, when the component loading place is full, it is difficult to move components in step 3 which is a previous step, and accordingly an event computation process in step 4 affects an event computation process in step 3. Next, from the step effect relationship acquired as described above, by putting the steps that affect one another into a block, the production line is divided into a plurality of blocks which do not affect each other. As a result, as shown in a lower part of FIG. 22, the entire production line can be expressed as a form in which the blocks which affect only each other in one direction are connected to each other. In a case where the earliest execution date and time of an event in a certain block is later than the earliest execution date and time of an event in another block which the certain block affects, an event group which can be computed in parallel is formed by determining that the event with the earliest execution date and time of the certain block is an event which can be computed in parallel. The formed event group is allocated to a plurality of processors so as to be computed in parallel, and thus, computation time is shortened. Hereinafter, the embodiment will be described in more detail.

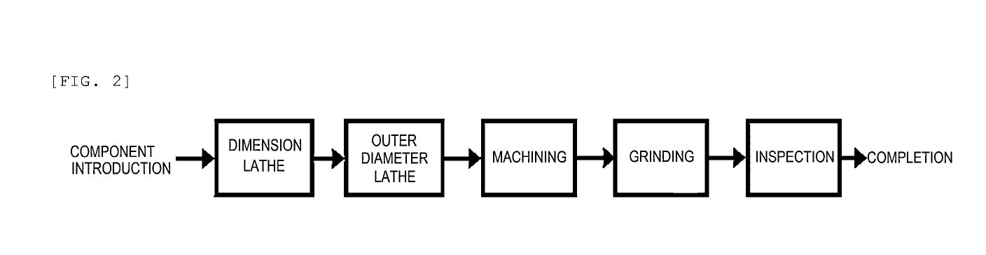

In the invention, a production simulation for predicting future flow of a production line is set as a target. FIG. 2 is an example of a step flow of a certain production line. In the step flow of the production line shown in FIG. 2, there are a plurality of steps such as dimension lathing, outer shape lathing. Hereinafter, a specific embodiment of the invention will be described with this example as a target.

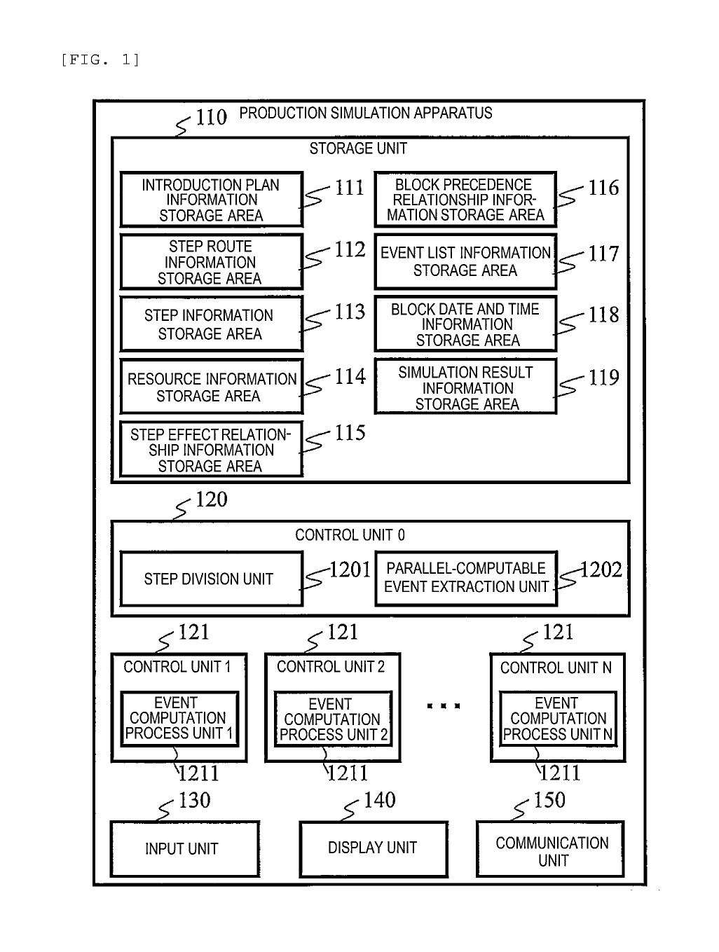

FIG. 1 is a functional block diagram of a production simulation apparatus. As shown in the drawing, the production simulation apparatus includes a storage unit 110, control units 120 and 121, an input unit 130, a display unit 140, and a communication unit 150. The storage unit 110 includes an introduction plan information storage area 111, a step route information storage area 112, a step information storage area 113, a resource information storage area 114, a step effect relationship information storage area 115, a block precedence relationship information storage area 116, an event list information storage area 117, and a simulation result information storage area 118.

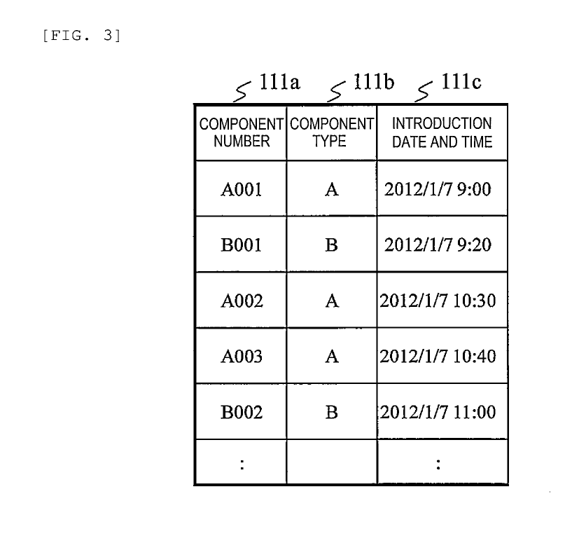

The introduction plan information storage area 111 stores introduction plan information for specifying a component number to be introduced into the production line, the type of the component, and introduction date and time of the component. For example, in the embodiment, an introduction plan information table as shown in FIG. 3 is stored. As shown in the drawing, the introduction plan information table includes a component number column 111a, a component type column 111b, and an introduction date and time column 111c. The component number column 111a stores information for specifying the component. The component type column 111b stores information for specifying the type of the component specified in the component number column 111a. The introduction date and time column 111c stores information for specifying the introduction date and time of the component specified in the component number column 111a.

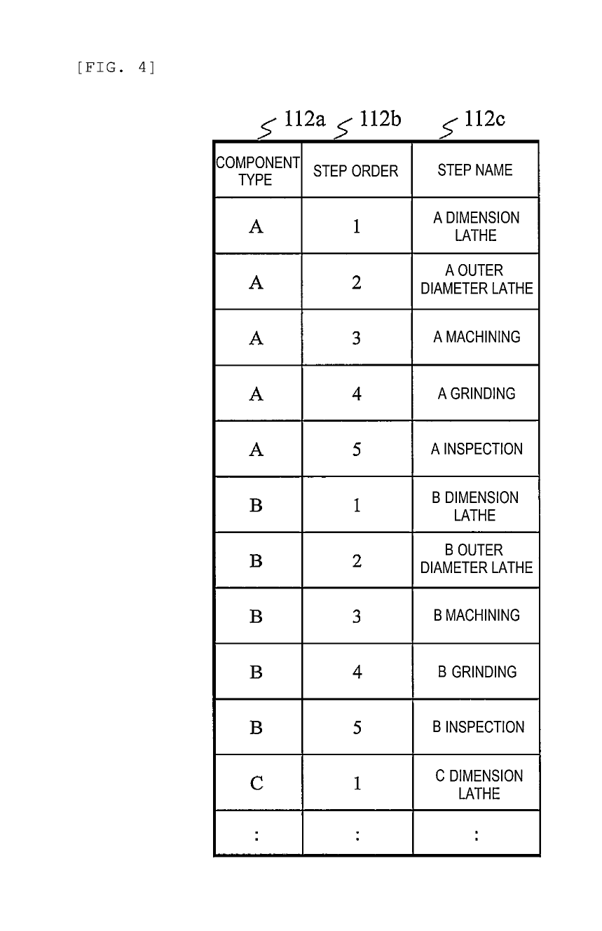

Returning to FIG. 1, the step route information storage area 112 stores step order information and step name information for each type of component. For example, in the embodiment, a step route information table as shown in FIG. 4 is stored. As shown in the drawing, the step route information table includes a component type column 112a, a step order column 112b, and a step name column 112c. The component type column 112a stores information for specifying the type of the component. The step order column 112b stores information for specifying a serial number of a process order of the step with respect to the type of component specified in the component type column 112a. The step name column 112c stores information for specifying the name of the step of the type of the component specified in the component type column 112a based on the step order specified in the step order column 112b.

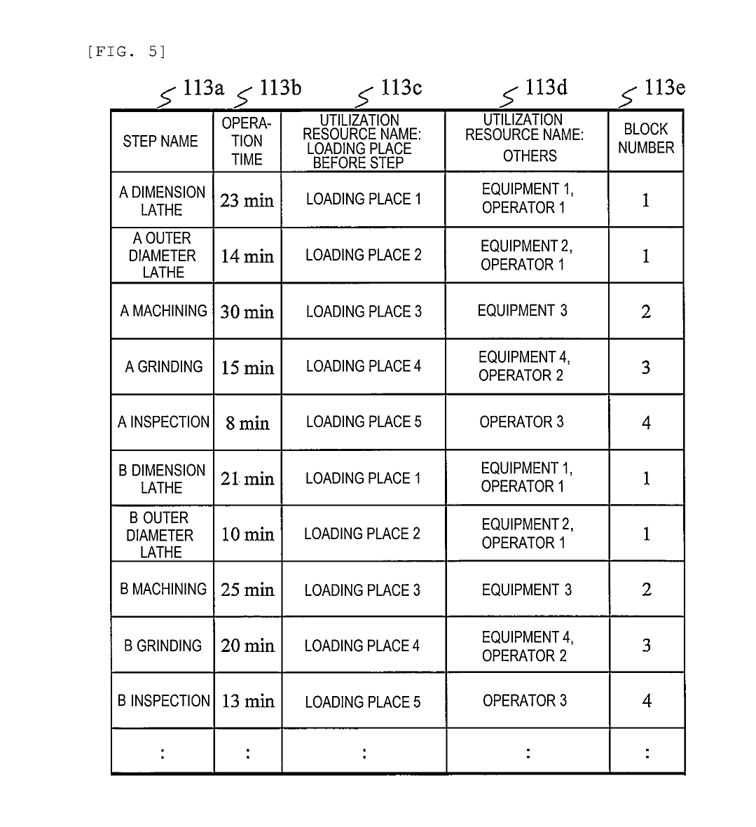

Returning to FIG. 1, the step information storage area 113 stores step information for specifying a step name, operation time for the step, a utilization resource name in the step, a block number to which the step belongs. For example, in the embodiment, a step information table as shown in FIG. 5 is stored. As shown in the drawing, the step information table includes a step name column 113a, an operation time column 113b, a utilization resource name: loading place before step column 113c, a utilization resource name: others column 113d, and a block number column 113e. The step name column 113a stores information for specifying the step name. The operation time column 113b stores information for specifying the operation time for the step specified in the step name column 113a. The utilization resource name: loading place before step column 113c stores information for specifying the component loading place used in the step specified in the step name column 113a. The utilization resource name: others column 113d stores information for specifying the resource name of used equipment or an operator in the step specified in the step name column 113a. The block number column 113e stores information for specifying the block number to which the step specified in the step name column 113a belongs.

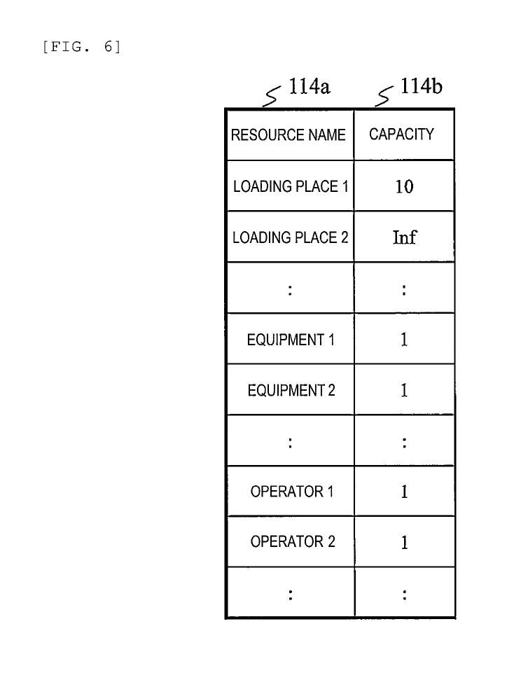

Returning to FIG. 1, the resource information storage area 114 stores resource information for specifying the resource name or capacity for the resource. For example, in the embodiment, a resource information table as shown in FIG. 6 is stored. As shown in the drawing, the resource information table includes a resource name column 114a and a capacity column 114b. The resource name column 114a stores information for specifying the resource name. The capacity column 114b stores information for specifying the capacity for the resource specified in the resource name column 114a.

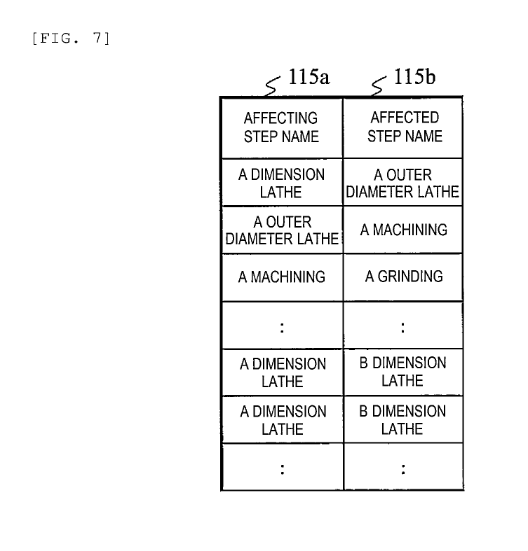

Returning to FIG. 1, the step effect relationship information storage area 115 stores step effect relationship information for specifying an affecting step name and an affected step name. For example, in the embodiment, a step effect relationship information table as shown in FIG. 7 is stored. As shown in the drawing, the step effect relationship information table includes an affecting step name column 115a and an affected step name column 115b. The affecting step name column 115a stores information for specifying the name of the step. The affected step name column 115b stores information for specifying the name of the step with an event computation process result which may be affected, among the other steps, when a computation process of an event in the step specified in the affecting step name column 115a is executed. For example, FIG. 7 indicates that a result obtained by executing a computation process of an event in an A dimension lathing step affects an execution result of a computation process of an event in an A outer diameter lathing step.

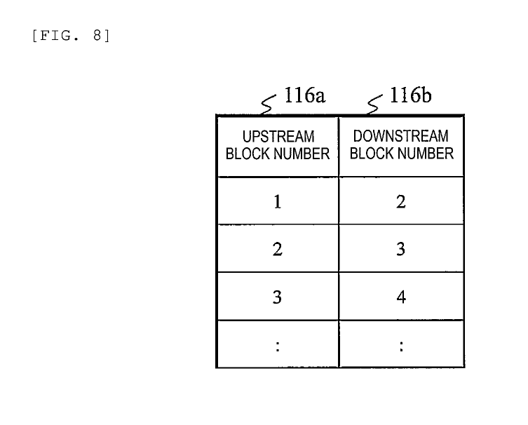

Returning to FIG. 1, the block precedence relationship information storage area 116 stores information for specifying a block number when the production line is divided into the plurality of blocks, and a block number of a downstream block of the block specified by the block number. For example, in the embodiment, a block precedence relationship information table as shown in FIG. 8 is stored. As shown in the drawing, the block precedence relationship information table includes an upstream block number column 116a and a downstream block number column 116b. The upstream block number column 116a stores information for specifying the block number. The downstream block number column 116b stores information for specifying the block number of the downstream block of the block specified in the upstream block number column 116a. For example, in FIG. 22, the downstream block of a block 1 is a block 2, and the downstream block of the block 2 is a block 3. In this case, the block precedence relationship information table stores a record with 1 in the upstream block number column and 2 in the downstream block number column, and a record with 2 in the upstream block number column and 3 in the downstream block number column.

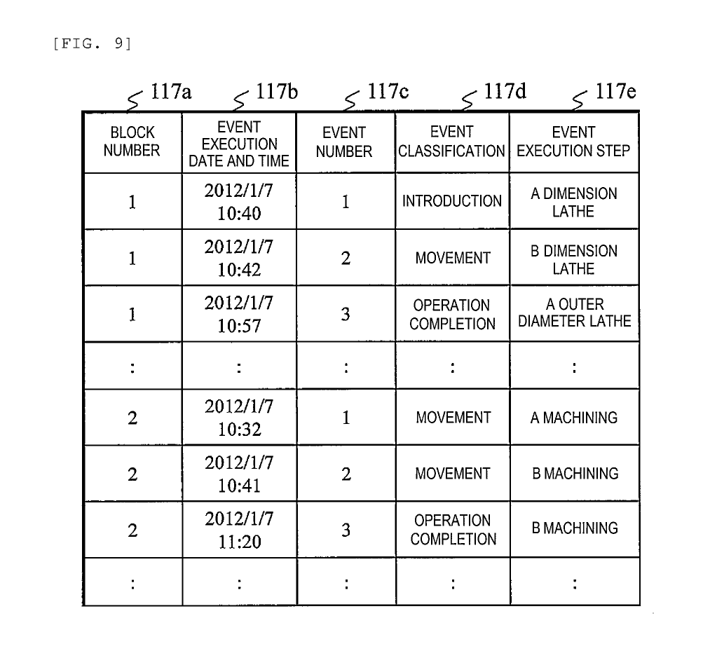

Returning to FIG. 1, the event list information storage area 117 stores information of the event list when executing the production simulation. For example, in the embodiment, an event list information table as shown in FIG. 9 is stored. As shown in the drawing, the event list information table includes a block number column 117a, an event execution date and time column 117b, an event number column 117c, an event classification column 117d, and an event execution step column 117e. The block number column 117a stores information for specifying the block number. The event execution date and time column 117b stores information for specifying the execution date and time of the event in the simulation. The event number column 117c stores information for specifying a serial number when the events of the block specified in the block number column 117a are arranged in ascending order of the event execution date and time. The event classification column 117d stores information for specifying the classification of the event. The classification is, for example, introduction, movement, or operation completion. The introduction indicates an event in which a component is introduced into the production line, the movement indicates an event in which the component is moved from the current step to the next step, and the operation completion indicates an event in which the operation of the current step with the component is completed. The event execution step column 117e stores information for specifying the step of executing the event.

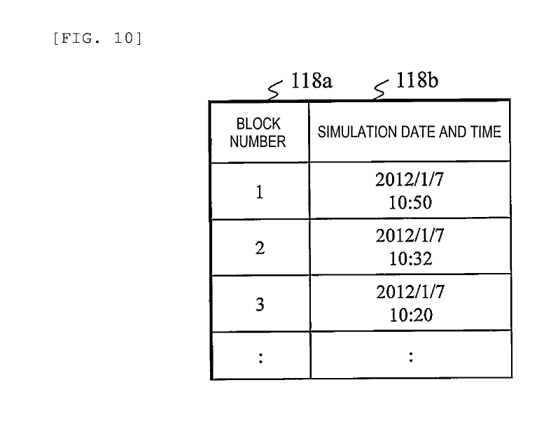

Returning to FIG. 1, the block date and time information storage area 118 stores information indicating the date and time the simulation of the block is completed during the execution of the production simulation. For example, in the embodiment, a block date and time information table as shown in FIG. 10 is stored. As shown in the drawing, the block date and time information table includes a block number column 118a and a simulation date and time column 118b. The block number column 118a stores information for specifying the block number. The simulation date and time column 118b stores information for specifying the simulation date and time that the block specified in the block number column 118a is completed during the execution of the production simulation.

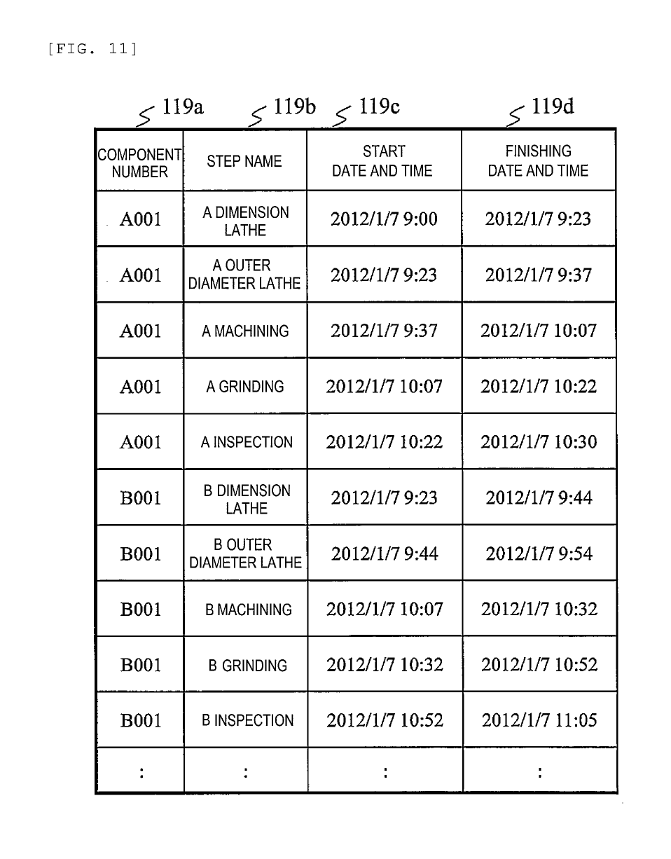

Returning to FIG. 1, a simulation result information storage area 119 stores start and finishing date and time information for each step of each component, as results of the production simulation. For example, in the embodiment, a simulation result information table as shown in FIG. 11 is stored. As shown in the drawing, the simulation result information table includes a component number column 119a, a step name column 119b, a start date and time column 119c, and a finishing date and time column 119d. The component number column 119a stores information for specifying the component. The step name column 119b stores information for specifying the step. The start date and time column 119c and the finishing date and time column 119d stores information for specifying the start date and time and the finishing date and time of the step specified in the step name column 119b of the component specified in the component number column 119a.

Returning to FIG. 1, the control unit 120 includes a step division unit 1201 and a parallel-computable event extraction unit 1202. The step division unit 1201 performs a process of dividing the production line into the plurality of blocks so that there is no mutual effect between the blocks due to the event execution, based on the step route information, the step information, and the resource information. The process will be specifically described later.

The parallel-computable event extraction unit 1202 performs a process of extracting an event group which can be computed in parallel, from the events with the earliest execution date and time in each block. The process will be specifically described later.

The control unit 121 includes an event computation process unit 1211. The event computation process unit 1211 performs a computation process of the event execution. The present apparatus includes the control unit 121 for each processor.

The input unit 130 receives input of the information stored in the storage unit by a user of the production simulation apparatus. The display unit 140 outputs the information of the storage unit 110. For example, the display unit 140 performs a process of displaying the information in the event list information storage area 117 or the information in the simulation result information storage area 119 of the storage unit 110. The communication unit 150 performs transmission and reception of the information through a network.

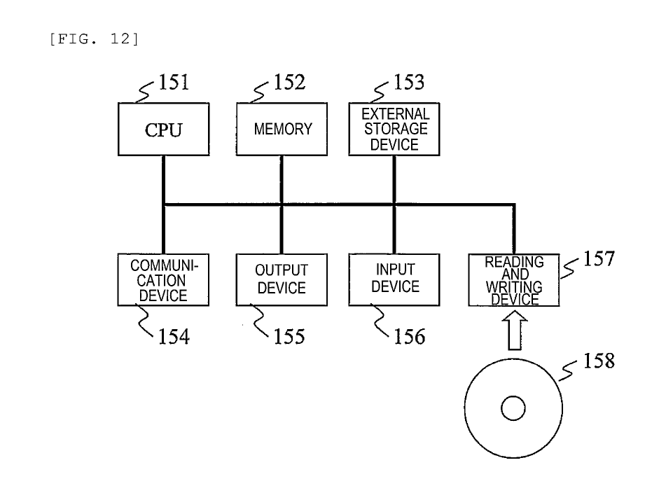

The production simulation apparatus described above, for example, can be utilized with a general computer including a central processing unit (CPU) 151, a memory 152, an external storage device 153 such as a hard disk drive (HDD), a reading and writing device 157 which reads and writes information with respect to a storage medium 158 having portability such as a compact disk (CD) or a digital versatile disk (DVD), an input device 156 such as a keyboard or a mouse, an output device 155 such as a display, and a communication device 154 such as a network interface card (NIC) for connecting to a communication network, as shown in FIG. 12.

For example, the storage unit 110 can be realized by using the memory 152 or the external storage device 153 by the CPU 151, the control unit 120 can be realized by loading a predetermined program stored in the external storage device 153 in the memory 152 and executing the program with the CPU 151, the input unit 130 can be realized by using the input device 156 with the CPU 151, the display unit 140 can be realized by using the output device 155 with the CPU 151, and the communication unit 150 can be realized by using the communication device 154 with the CPU 151.

The predetermined program may be downloaded to the external storage device 153, from the storage medium 158 through the reading and writing device 157 or from the network through the communication device 154, and then loaded on the memory 152 to be executed by the CPU 151. In addition, the predetermined program may be directly loaded on the memory 152 from the storage medium 158 through the reading and writing device 157 or from the network through the communication device 154, to be executed by the CPU 151.

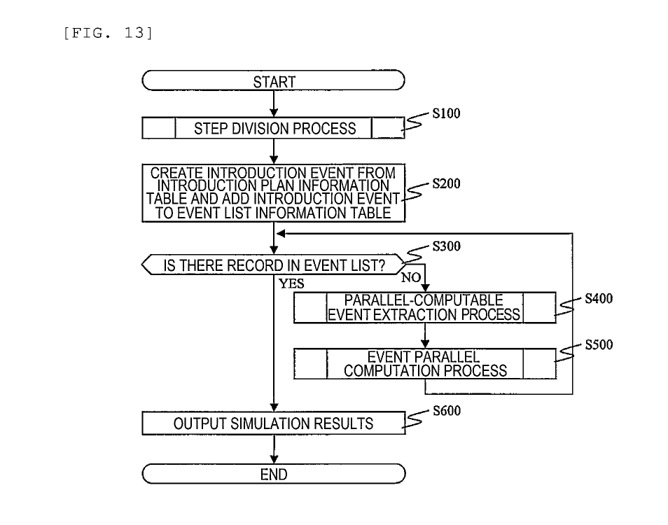

The production simulation apparatus described above realizes a simulation with shortened computation time by using the plurality of processors, by the production simulation process which will be described later. FIGS. 13 to 21 are flowcharts showing the production simulation processes. Hereinafter, the embodiment of the invention will be described in detail with reference to FIGS. 13 to 21.

FIG. 13 is a flowchart of the production simulation process. Before starting the production simulation process, a user inputs information necessary for the simulation through the input unit 130, and the information is stored in the storage unit 110. The information described above such as the introduction plan information, the step route information, the step information (excluding block number), and the resource information are input in advance. In Step S100, the production line is divided into the plurality of blocks. This process will be specifically described later. In Step S200, an introduction event is created from the introduction plan information table, and the information of the created event is stored in the event list information table. In Step S300, it is determined whether or not there is a record in the event list, and when it is determined that there is a record, the process proceeds to Step S400, and when it is determined that there is no record, the process proceeds to Step S600. In Step S400, the events which can be computed in parallel are extracted from the event list. This process will be specifically described later. In Step S500, the event execution computation process with respect to the extracted events which can be computed in parallel is performed by using the plurality of processors. When there is no event which can be computed in parallel, the event execution computation process is performed by using one processor. As a result of the event computation process, the event which newly occurs is added to the event list information table. The event is acquired from the event list information table and the event computation process is performed. The computation process is repeatedly performed until there is no record in the event list information table. This process will be specifically described later. In Step S600, the simulation result is output and the simulation ends.

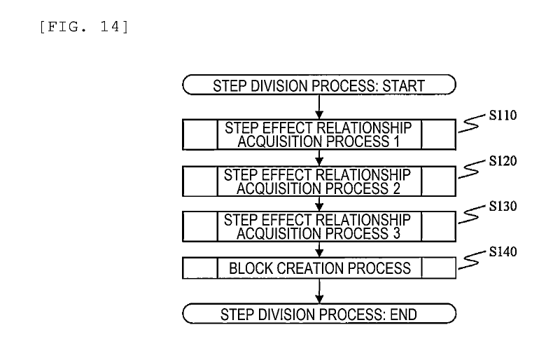

Hereinafter, the step division process in Step S100 of FIG. 13 will be described in detail. FIG. 14 is a flowchart showing this process in detail. In Step S110, a step effect relationship acquisition process 1 is executed. In this process, information regarding a step affect relationship due to the order relationship of the steps is acquired. This process will be specifically described later. In Step S120, a step effect relationship acquisition process 2 is executed. In this process, information regarding a step affect relationship due to the full component loading place with finite capacity is acquired. This process will be specifically described later. In Step S130, a step effect relationship acquisition process 3 is executed. In this process, information regarding a step affect relationship due to resource sharing between the steps is acquired. This process will be specifically described later. In Step S140, a block creation process is executed. In this process, the production line is divided into the plurality of blocks, based on the step affect relationships acquired in the step effect relationship acquisition processes 1, 2, and 3. This process will be specifically described later.

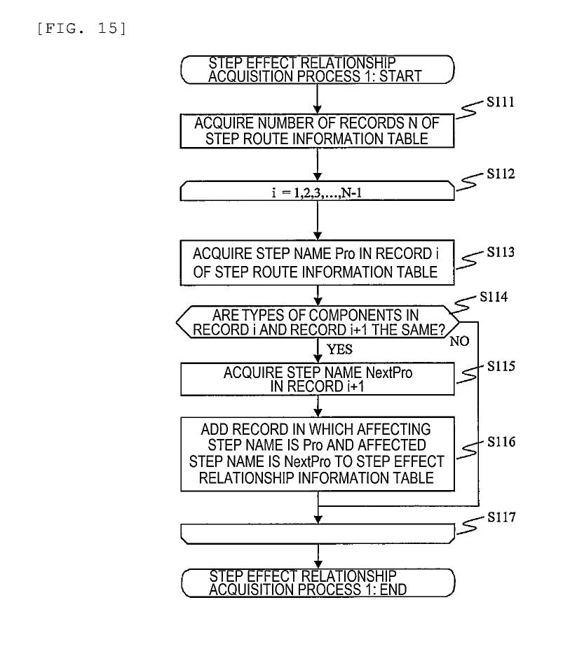

Hereinafter, the step effect relationship acquisition process 1 in Step S110 of FIG. 14 will be described in detail. In this process, the record is added to the step effect relationship table, based on the order relationship of the steps in the step route of each type of component. Herein, the record in which the affecting step is set as the upstream step and the affected step is set as the downstream step is added by using the relationship that the event execution in the upstream step affects the event execution in the downstream step on the step route. FIG. 15 is a flowchart showing this process in detail.

In Step S111, the number of records in the step route information table is acquired and the acquired value is substituted with N. Steps S113 to S117 are repeated in the range of a counter i which is from 1 to N−1. In Step S113, the step name of the record i in the step route information table (i-th record from the top of the table) is acquired, and the acquired value is substituted with Pro. In Step S114, it is determined whether or not the types of components of the record i and the record i+1 in the step route information table are the same as each other. In a case where the types are the same as each other, the process proceeds to Step S115, and in a case where the types are not the same as each other, the process proceeds to Step S117. In Step S115, the step name of the record i+1 in the step route information table is acquired, and the acquired value is substituted with NextPro. In Step S116, a record in which the affecting step name is Pro and the affected step name is NextPro is added to the step effect relationship table.

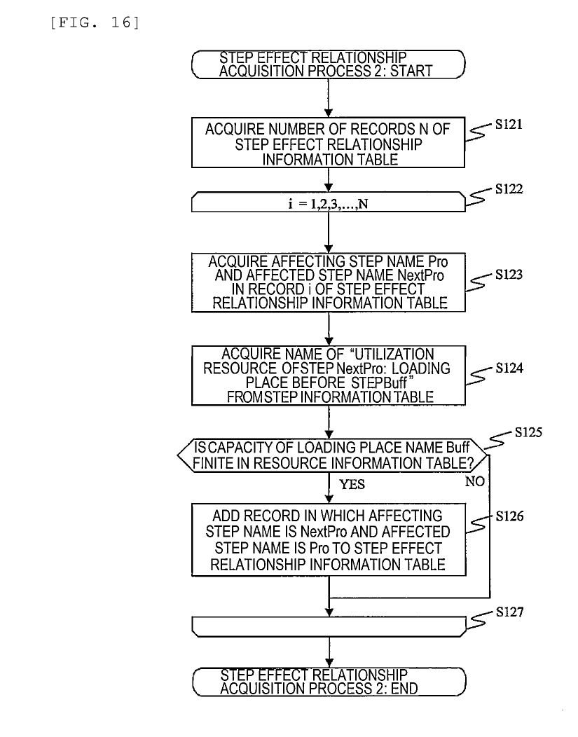

Hereinafter, the step effect relationship acquisition process 2 in Step S120 of FIG. 14 will be described in detail. In a case where the loading place used in the downstream step has finite capacity on the step route, the loading place may be filled with the components, and the components may not be moved from the upstream step. In this case, the event execution result in the downstream step affects the event execution result in the upstream step. In this process, based on the phenomenon described above, regarding each record in the step effect relationship information table added in the step effect relationship acquisition process 1, when the capacity of the component loading place used in the affected step, that is, the downstream step on the step route, is a finite value, the record in which the affecting step is set as the downstream step and the affected step is set as the upstream step is added. FIG. 16 is a flowchart showing this process in detail.

In Step S121, the number of records in the step effect relationship information table is acquired and the acquired value is substituted with N. Steps S123 to S127 are repeated in the range of a counter i which is from 1 to N. In Step S123, the affecting step name and the affected step name of the record in the step effect relationship information table are acquired, and the acquired values are substituted with Pro and NextPro, respectively. In Step S124, the name of “utilization resource of NextPro: loading place before step” is acquired from the step information table, and the acquired value is substituted with Buff. In Step S125, it is determined whether or not the capacity of the loading place Buff is a finite value in the resource information table. When the capacity thereof is a finite value, the process proceeds to Step S126, and when the capacity thereof is not a finite value, the process proceeds to Step S127. In Step S126, the record in which the affecting step name is set as NextPro and the affected step name is set as Pro is assigned to the step effect relationship information table.

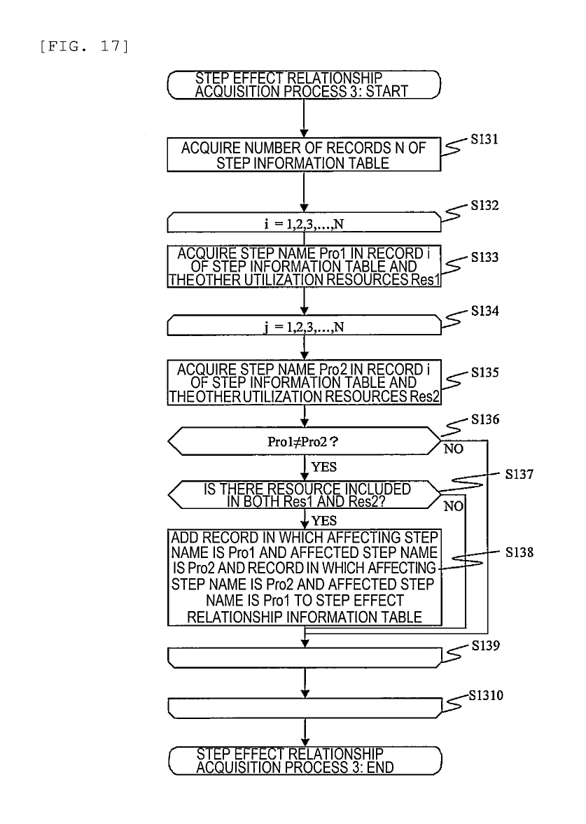

Hereinafter, the step effect relationship acquisition process 3 in Step S130 of FIG. 14 will be described in detail. When the plurality of steps share a resource, for example, when a step A and a step B share equipment 1, the event execution result in the step A affects the event execution result in the step B. In addition, the event execution result in the step B affects the event execution result in the step A. In this process, the record in which each of the two steps which share a resource are set as the affecting step and the affected step, is added to the step effect relationship information table. FIG. 17 is a flowchart showing this process in detail.

In Step S131, the number of records in the step information table is acquired and the acquired value is substituted with N. Steps S133 to S1310 are repeated in the range of a counter i which is from 1 to N.

In Step S133, the step name of the record i in the step information table is acquired and the acquired value is substituted with Pro1. In addition, the “utilization resource of Pro1: others” is acquired and the acquired value is substituted with Res1. Steps S135 to S139 are repeated in the range of a counter j which is from 1 to N. In Step S135, the step name of the record j in the step information table is acquired and the acquired value is substituted with Pro2. In addition, the “utilization resource of Pro2: others” is acquired and the acquired value is substituted with Res2. In Step S136, it is determined whether or not the Pro1 and the Pro2 are the same as each other. When they are the same as each other, the process proceeds to Step S139, and when they are not the same as each other, the process proceeds to Step S137. In Step S137, it is determined whether or not there is a resource including both of the Res1 and the Res2. When there is a resource including both of the Res1 and the Res2, the process proceeds to Step S138, and when there is no resource including both of the Res1 and the Res2, the process proceeds to Step S139. In Step S138, the records in which the affecting step name is set as Pro1 and the affected step name is set as Pro2, and the record in which the affecting step name is set as Pro2 and the affected step name is set as Pro1 are added to the step effect relationship information table.

In this example, only the step effect relationship acquisition process using the information of the step route or the utilization resource which is input data of the simulation has been described, but the invention is not limited to the method of the step effect relationship acquisition process. For example, even in the case of controlling the order of the components to be processed in the previous step according to the set number of components on each date and time in the later step, the event computation process result of the later step affects the event computation process result of the previous step. As described above, if the information which varies with time such as the set number of components in a certain step A is used in the event computation process in the other step B, the step effect relationship by which the event computation process result of the step A affects the event computation process result of the step B may be acquired.

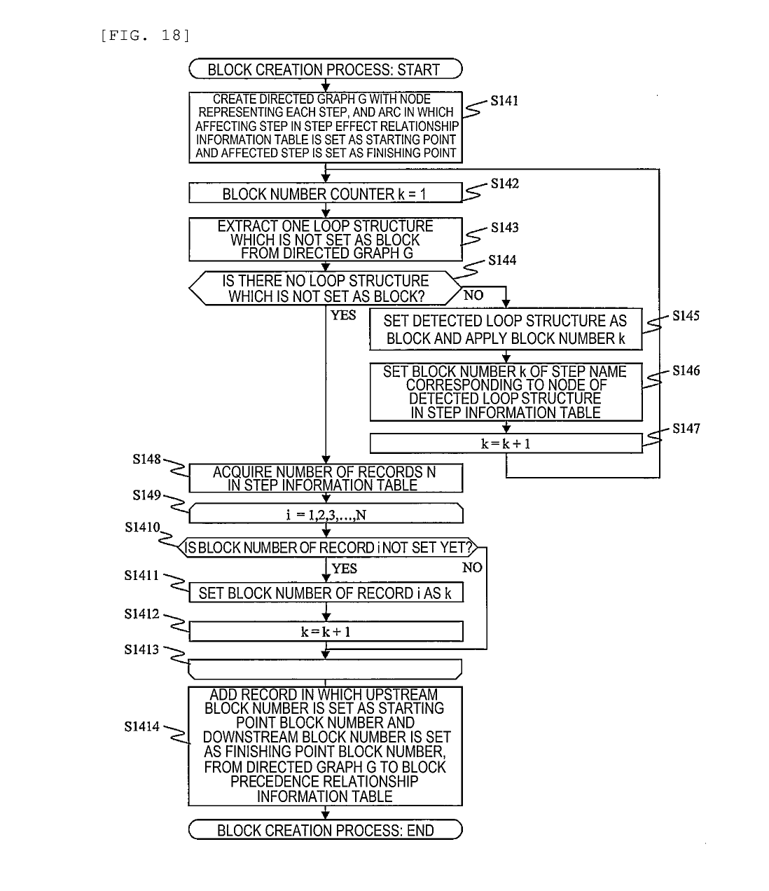

Hereinafter, the block creation step in Step S140 of FIG. 14 will be described in detail. In this process, the production line is divided into the plurality of blocks, so that there are effects between the blocks only in one direction, based on the information in the step effect relationship information table created in the process described above. FIG. 18 is a flowchart showing this process in detail.

In Step S141, a directed graph indicating the effect relationship between the steps is created, with a node representing each step, and an arc in which the affecting step in the step effect relationship information table is set as a starting point and the affected step is set as a finishing point. In Step S142, a block number counter k is set as 1. In Step S143, one loop structure which is not set as a block is detected from the directed graph. In Step S144, it is determined whether or not there is a loop structure which is not set as a block. When there is a loop structure thereof, the process proceeds to Step S145, and when there is no loop structure thereof, the process proceeds to Step S148. In Step S145, the detected loop structure is set as a block on the directed graph, and a block number k is applied thereto. In Step S146, in the step information table, the block number of the step corresponding to the configuration node of the detected loop structure is set as k. In Step S147, 1 is added to k. In Step S148, the number of records in the step information table is acquired and the acquired value is substituted with N. Steps S1410 to S1413 are repeated in the range of a counter i which is from 1 to N. In Step S1410, it is determined whether or not the block number of the record is not yet set in the step information table. When the block number thereof is not yet set, the process proceeds to Step S1411, and when the block number thereof is already set, the process proceeds to Step S1413. In Step S1411, the block number of the record i in the step information table is set as k. In Step S1412, 1 is added to k.

In Step S1414, the information regarding the combination of the block number at the starting point of the arc and the block number at the finishing point of the arc is acquired from the directed graph, and the record in which the upstream block number is set as the starting point block number and the downstream block number is set as the finishing point block number is added to the block precedence relationship information table.

By performing the processes described above, the setting of the block number with respect to each step and the acquisition of the block precedence relationship are completed. In this example, a method of setting a block due to the creation of the directed graph and the detection of the loop structure has been described, but it is not necessary to actually create the directed graph on the computer, and the same process may be realized by using the information in the step effect relationship information table.

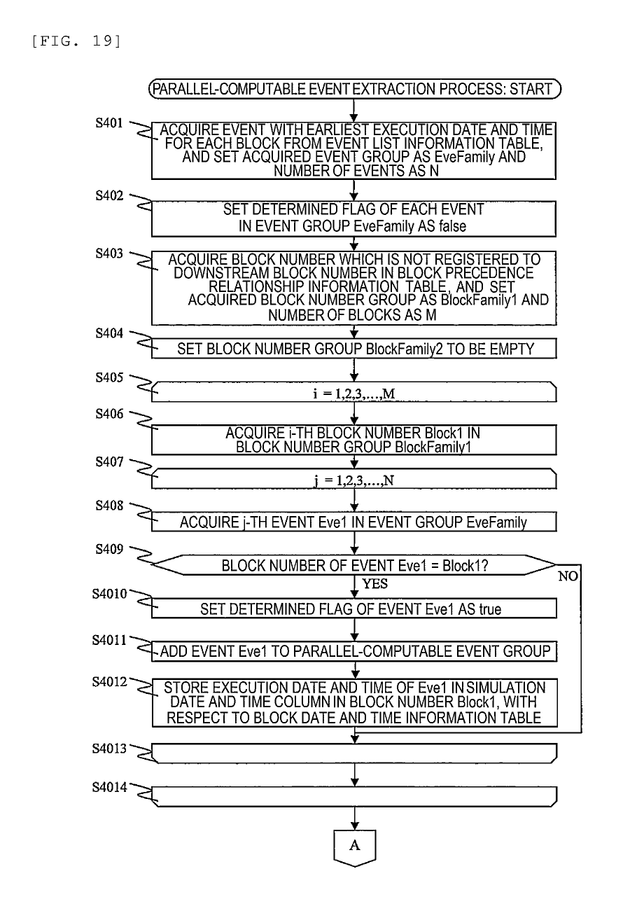

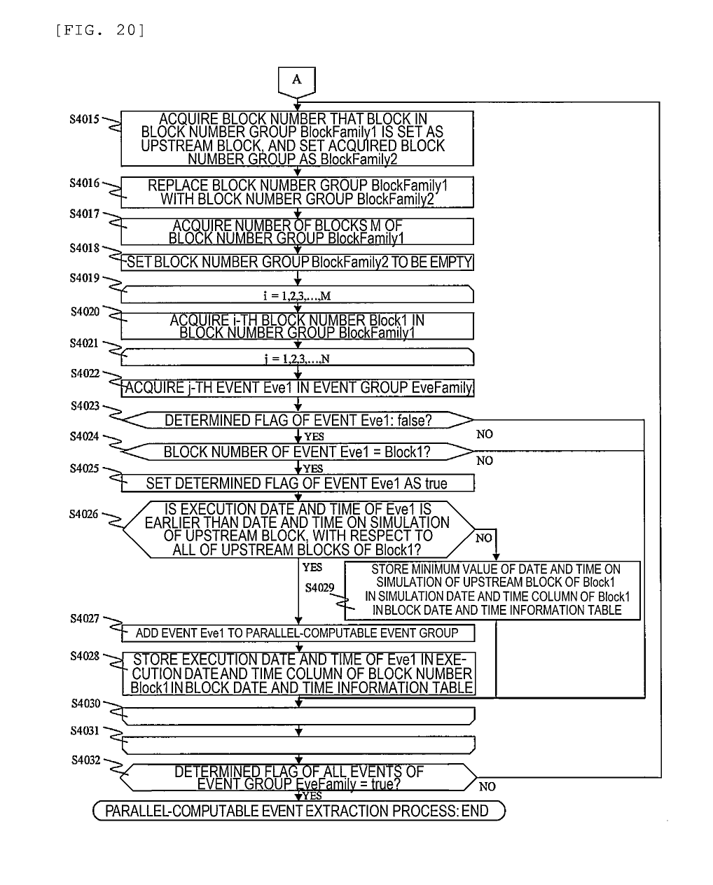

Hereinafter, the parallel-computable event extraction process in Step S400 of FIG. 13 will be described in detail. In this process, the event group which can be computed in parallel is extracted from the event with the earliest execution date and time in each block, based on the block number of each step and the block precedence relationship acquired in the step division process. In detail, among the upstream block and the downstream block, the execution date and time of the event in the upstream block and the execution date and time of the event in the downstream block are compared to each other, and if a relationship in which the execution date and time of the upstream block>the execution date and time of the downstream block (the execution date and time of the upstream block comes after the execution date and time of the downstream block) is satisfied, the event in the downstream block is extracted as the event which can be computed in parallel. FIGS. 19 and 20 are flowcharts showing this process in detail.

In Steps S401 to S4014, the event in the uppermost stream block is identified as the event which can be computed in parallel. In Step S401, the event with the earliest execution date and time for each block is acquired from the event list information table, the acquired event group is substituted with EveFamily, and the acquired number of events is substituted with N. In Step S402, a determined flag of each event in the event group EveFamily is set as false. In Step S403, in the block precedence relationship information table, the block number which is not registered to the downstream block number is acquired, the acquired block number group is substituted with BlockFamily1, and the acquired number of blocks is substituted with M.

In Step S404, the block number group BlockFamily2 is set to be empty. Steps S406 to S4014 are repeated in the range of a counter i which is from 1 to M. In Step S406, the i-th block number in the block number group BlockFamily1 is acquired, and the acquired block number is set as Block1. Steps S408 to S4013 are repeated in the range of a counter j which is from 1 to N. In Step S408, the j-th event in the event group EveFamily is acquired, and the acquired event is set as Eve1. In Step S409, it is determined whether or not the block number of the event Eve1 coincides with Block1. When they coincide with each other, the process proceeds to Step S4010, and when they do not coincide with each other, the process proceeds to Step S4013. In Step S4010, the determined flag of the event Eve1 is set as true. In Step S4011, the event Eve1 is added to the event group which can be computed in parallel. In Step S4012, with respect to the block date and time information table, the execution date and time of Eve1 is stored in the simulation date and time column in the record in which the block number is set as Block1.

Next, in Steps S4015 to S4031, the event which can be computed in parallel is extracted sequentially from the uppermost stream block to the downstream block. In Step S4015, the block number in which the block in the block number group BlockFamily1 is set as the upstream block is acquired, and the acquired block number group is substituted with BlockFamily2. In Step S4016, the block number group BlockFamily1 is replaced with the block number group BlockFamily2. In Step S4017, the number of blocks of the block number group BlockFamily1 is acquired, and the acquired number of blocks is substituted with M. In Step S4018, the block number group BlockFamily2 is set to be empty. Steps S4020 to S4031 are repeated in the range of a counter i which is from 1 to M. In Step S4020, the i-th block number in the block number group BlockFamily1 is acquired, and the acquired block number is substituted with Block1.

Steps S4022 to S4030 are repeated in the range of a counter j which is from 1 to N. In Step S4022, the i-th event in the event group EveFamily is acquired, and the acquired event is substituted with Eve1. In Step S4023, it is determined whether or not the determined flag of the event Eve1 is set as false. When the flag thereof is set as false, the process proceeds to Step S4024, and when the flag thereof is not set as false, the process proceeds to Step S4029.

In Step S4024, it is determined whether or not the block number of the event Eve1 coincides with Block1. When they coincide with each other, the process proceeds to Step S4025, and when they do not coincide with each other, the process proceeds to Step S4029. In Step S4025, the determined flag of the event Eve1 is set as true. In Step S4026, it is determined whether or not the execution date and time of the Eve1 is earlier than the execution date and time of all of the upstream blocks of Block1. When the execution date and time of the Eve1 is earlier than the execution date and time thereof, the process proceeds to Step S4027, and when execution date and time of the Eve1 is not earlier than the execution date and time thereof, the process proceeds to Step S4029. In Step S4027, the event Eve1 is added to the event group which can be computed in parallel. In Step S4028, with respect to the block date and time information table, the execution date and time of Eve1 is stored in the simulation date and time column in the record in which the block number is set as Block1.

In Step S4029, with respect to the block date and time information table, a minimum value of the date and time on the simulation of the upstream block of Block1 is stored in the simulation date and time column in the record in which the block number is set as Block1. In Step S4032, it is determined whether or not the determined flag of all of the events in the event group EveFamily is set as true. When the flag thereof is set as true, the parallel-computable event extraction process ends, and when the flag thereof is not set as true, the process proceeds to Step S4015.

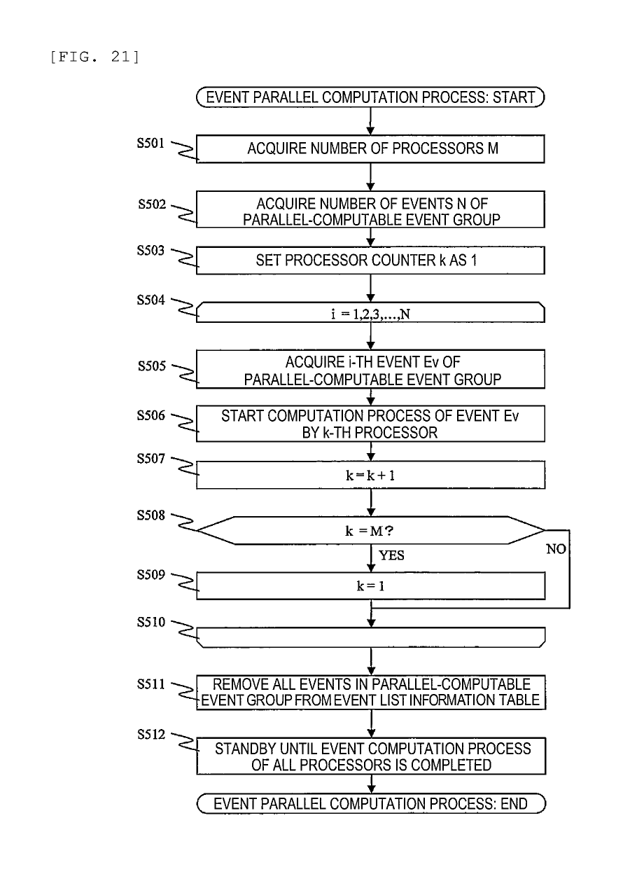

Hereinafter, the event parallel computation process in Step S500 of FIG. 13 will be described in detail. In this process, the parallel execution of the event computation process is performed by allocating the event in the parallel-computable event group which is the process result of the parallel-computable event extraction process to the plurality of processors. FIG. 21 is a flowchart showing this process in detail.

In Step S501, the number of processors is acquired, and the acquired value is substituted with M. As a method of acquiring the number of processors, there is a method of acquiring the number of processors of the computer or performing setting by a user of this apparatus, but the invention is not limited in the method thereof. In Step S502, the number of event groups which can be computed in parallel is acquired, and the acquired value is substituted with N. In Step S503, a processor counter k is set as an initial value 1. Steps S505 to S510 are repeated in the range of a counter which is from 1 to N.

In Step S505, the i-th event of the event group which can be computed in parallel is acquired, and the acquired event is set as Ev. In Step S506, k-th processor starts the computation process of the event Ev. In Step S507, 1 is added to the processor counter k. In Step S508, it is determined whether or not k is equivalent to M. When they are equivalent to each other, the process proceeds to Step S509, and when they are not equivalent to each other, the process proceeds to Step S510.

In Step S509, the processor counter k is set as 1. In Step S511, all events in the event group which can be computed in parallel are removed from the event list information table. In Step S512, the process remains in a standby state until all the event computation processes of M processors are completed.

The parallel execution of the event computation process by the plurality of processors can be realized by the processes described above. In this example, the number of events to be processed by each processor is equalized by allocating each event to each of the M processors, but the invention is not limited to this method. For example, a method of monitoring a load state of each processor and sequentially allocating the event to the processor with a small load may be used. In this example, in Step S512, the process remains in a standby state until the event computation processes of all processors are completed, but the invention is not limited to such a standby process. For example, the process may remain in a standby state until the event computation process of at least one processor is completed, or the process may not be on standby for the completion of event computation process.

The event process results are stored in the simulation result information storage area 119 as the simulation result information table shown in FIG. 11. When a user performs analysis of the information in FIG. 11, rapid and accurate production planning and production line design can be realized. In this example, a process of allocating the computation process of one production simulation to the plurality of processors has been described, but this allocation process may be combined with the parallel execution of the plurality of production simulations having different input information items such as the introduction plan. For example, when executing two production simulations (scenarios A and B) having different input information items, by using eight processors, the computation process of the scenario A can be allocated to four processors and the computation process of the scenario B can be allocated to the remaining four processors, or the allocation can be performed so that the scenarios A and B share the eight processors without fixing the number of processors used for each scenario.

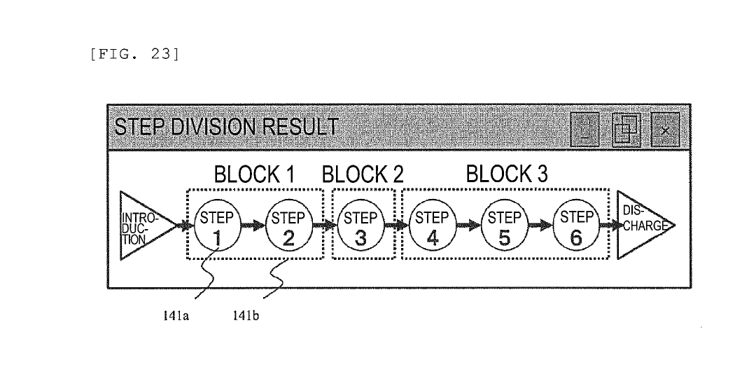

FIG. 23 is a schematic view showing an example of a display screen. FIG. 23 is a display screen for displaying information in the step information storage area 113 of the storage unit 110, and this display screen, for example, includes a step display area 141a and a block display area 141b. With this display screen, a user of this apparatus can check the block state of the production line.

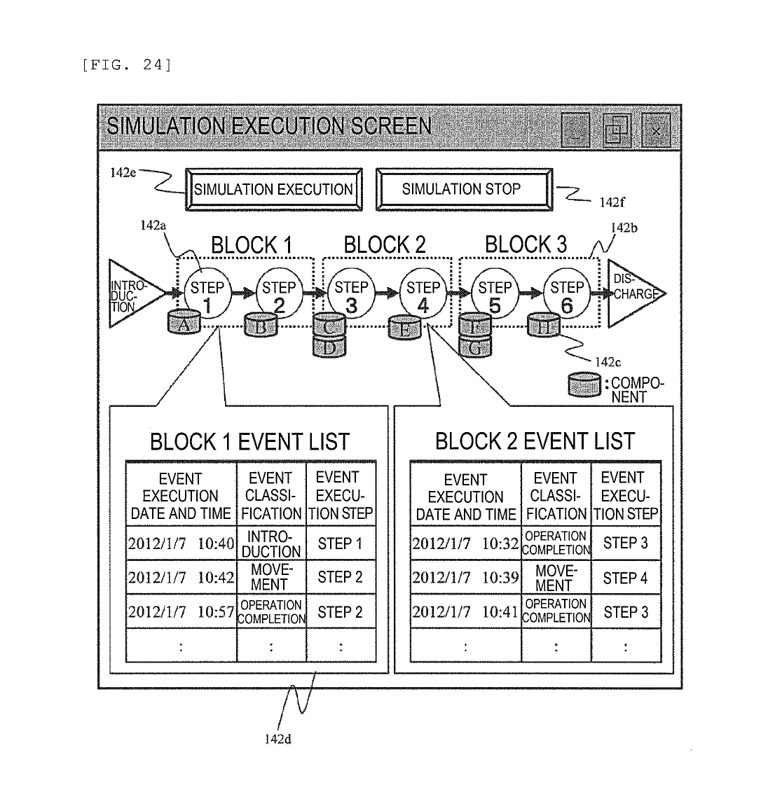

FIG. 24 is a schematic view showing an example of a display screen. FIG. 24 is a display screen for displaying information in the step information storage area 113, the event list information storage area 117, and the simulation result information storage area 119 of the storage unit 110, and this display screen, for example, includes a step display area 142, a block display area 142b, a set component display area in each step 142c, an event list display area 142d, a simulation execution button area 142e, and a simulation stop button area 142f. Using this display screen, a user of this apparatus can check the component setting state in each step and the information of the event list of each block during the execution of the simulation.

### REFERENCE SIGNS LIST

110 . . . STORAGE UNIT, 111 . . . INTRODUCTION PLAN INFORMATION STORAGE AREA, 112 . . . STEP ROUTE INFORMATION STORAGE AREA, 113 . . . STEP INFORMATION STORAGE AREA, 114 . . . RESOURCE INFORMATION STORAGE AREA, 115 . . . STEP EFFECT RELATIONSHIP INFORMATION STORAGE AREA, 116 . . . BLOCK PRECEDENCE RELATIONSHIP INFORMATION STORAGE AREA, 117 . . . EVENT LIST INFORMATION STORAGE AREA, 118 . . . BLOCK DATE AND TIME INFORMATION STORAGE AREA, 119 . . . SIMULATION RESULT INFORMATION STORAGE AREA, 120 . . . CONTROL UNIT 0, 121 . . . CONTROL UNITS 1 TO N, 1201 . . . STEP DIVISION UNIT, 1202 . . . PARALLEL-COMPUTABLE EVENT EXTRACTION UNIT, 1211 . . . EVENT COMPUTATION PROCESS UNIT, 130 . . . INPUT UNIT, 140 . . . DISPLAY UNIT, 150 . . . COMMUNICATION UNIT, 151 . . . CPU, 152 . . . MEMORY, 153 . . . EXTERNAL STORAGE DEVICE, 154 . . . COMMUNICATION DEVICE, 155 . . . OUTPUT DEVICE, 156 . . . INPUT DEVICE, 157 . . . READING AND WRITING DEVICE, 158 . . . STORAGE MEDIUM, 141a . . . STEP DISPLAY AREA, 141b . . . BLOCK DISPLAY AREA, 142a . . . STEP DISPLAY AREA, 142b . . . BLOCK DISPLAY AREA, 142c . . . SET COMPONENT DISPLAY AREA IN EACH STEP, 142d . . . EVENT LIST DISPLAY AREA, 142e . . . SIMULATION EXECUTION BUTTON AREA, 142f . . . SIMULATION STOP BUTTON AREA

1. A production simulation apparatus which predicts flow of a production line, the apparatus comprising:
an input unit which receives input of introduction plan information for specifying the date and time to introduce a component to the production line, step information for specifying content of each step of the production line, and step route information for specifying the order of the steps, which are input information items of the simulation;
a storage unit which stores the information input by the input unit; and
a control unit which executes a process of dividing the step of the production line into a plurality of blocks so that event computation process results do not mutually affect the blocks, by using the step information and the step route information, a process of forming an event group which can be computed in parallel from the order of the execution date and time of the event in each formed block based on the introduction plan information, a process of allocating the event group to a plurality of processors, and a computation process of the event allocated to each processor.

2. The production simulation apparatus according to claim 1,
wherein the step information includes information for specifying operation time of each step and a utilization resource in the step, and
the input unit further receives input of resource information for specifying capacity for a resource relating to each step, the storage unit stores the resource information, and the control unit divides the step of the production line into the plurality of blocks so that the event computation process results do not mutually affect the blocks, by using the resource information, based on the resource capacity and resource sharing between the steps.

3. The production simulation apparatus according to claim 1,
wherein the control unit compares the earliest execution date and time of the event of an upstream block with the earliest execution date and time of the event of a downstream block, in the order of the execution date and time of the event of each bock, and when the execution date and time of the event of the downstream block is earlier than the execution date and time of the event of the upstream block, forms the event of the upstream block and the event of the downstream block as an event group which can be computed in parallel.

4. The production simulation apparatus according to claim 1,
wherein information of occurring event is acquired based on the results of the computation process of the event, and the computation process is repeatedly performed.

5. The production simulation apparatus according to claim 1,
wherein the storage unit is set to store a plurality of information items which are different input information items, and the control unit performs an execution process of simulations of a plurality of scenarios having different input information items in parallel.

6. A production simulation method which predicts flow of a production line in a production simulation apparatus including a storage unit, an input unit, and a control unit, the method comprising:
a step of receiving input of introduction plan information for specifying date and time to introduce a component to the production line, step information for specifying content of each step of the production line, and step route information for specifying the order of the steps;
a step of storing the input information; and
a step of dividing the step of the production line into a plurality of blocks so that event computation process results do not mutually affect the blocks, by using the step information and the step route information;
a step of forming an event group which can be computed in parallel from the order of the execution date and time of the event in each block computed based on the introduction plan information;
a step of allocating the event group to a plurality of processors; and
a step of executing the computation process of the event allocated to each processor.

7. The production simulation method according to claim 6,
wherein the step information includes information for specifying the operation time of each step and a utilization resource in the step, and
the production simulation method further includes a step of receiving input of resource information for specifying capacity for a resource relating to each step, and storing the resource information,
in the step of dividing the step of the production line into the plurality of blocks, the step of the production line is divided into the plurality of blocks so that the event computation process results do not mutually affect the blocks, by using the resource information, based on the resource capacity and resource sharing between the steps.

8. The production simulation method according to claim 6,
wherein, in the step of forming the event group which can be computed in parallel, the earliest execution date and time of the event of an upstream block and the earliest execution date and time of the event of a downstream block are compared to each other, in the order of the execution date and time of the event of each block, and when the execution date and time of the event of the downstream block is earlier than the execution date and time of the event of the upstream block, the event of the upstream block and the event of the downstream block are formed as an event group which can be computed in parallel.

9. The production simulation method according to claim 6,
wherein information of occurring event is acquired based on the results of the computation process of the event, and the computation process is repeatedly performed.

10. The production simulation method according to claim 6,
wherein an execution process of simulations of a plurality of scenarios having different input information items is performed in parallel.
